(19) United States
(12) Patent Application Publication
(10) Pub. No.: US 2006/0026845 A1
(43) Pub. Date: Feb. 9, 2006

(54) Garden shear

(76) Inventor: Ming-Ling Lin, Taichung Hsien (TW)

Correspondence Address: CHARLES E. BAXLEY, ESQ., 90 JOHN STREET, THIRD FLOOR, NEW YORK, NY, 10038, US

(21) Appl. No.: 10/910,697

(22) Filed: Aug. 3, 2004

(51) Int. Cl. B26B 13/00

(52) U.S. Cl. 30/249

(57) ABSTRACT

A shear, containing a first blade and a second blade, and a first controlling pole and a second controlling pole, while the first and second controlling pole are respectively connected with a spindle to the first blade, the second controlling pole is also spindly connected to the second blade; a gear part is set at the point where the first controlling pole meet the second blade. A much better and efficient level system is applied to our invention, and the gear part in it can disperse the force and resistance when cutting branches bore by the few connections, consequently provide user a chance to save strength while at the same time easy to operate.

### BACKGROUND OF THE INVENTION

1. Field of the Invention

The present invention is used as a gardening tool, especially use for cutting branches.

2. Description of the Related Art

In gardening, it is a tuff task to cut branches, especially branches whose diameters are more than 2 inches. Therefore, special tools are needed. This newly invented shear is composed of two handles and two blades that can move easily towards and away to each other. The handles are much longer than the blades, so a better lever system is applied in this invention. It comes to be obvious that the major advantage of this kind of shear is that it can save users a lot of strength while cutting branches. In order to cope with the strong resistance we often encounter while cutting big branches we usually use shears with big handles made of hardwood or with heavy weight. But it is too heavy to be convenient.

In order to solve these problems, a new kind of shear which was introduced in U.S. Pat. No. 5,020,222 on Jun. 4, 1991 was invented to gain the best efficiency in cutting branches while at the same time bore the strong resistance. This shear is composed of the first and second blade, and a controlling pole. The pole is connected to the first blade and can also slide to the second blade as needed. So users can use different force in cutting branches according to the different diameter of them. The advantages are that it not only save users a lot of strength, but the handles can also be made of light materials so that it is much lighter and easier to be controlled.

In the shears discussed above, the force comes from opening and closing and resistance while cutting is concentrated on the two blades and several connecting parts on the controlling pole. This will cause the inefficiency in saving strength whiling cutting, because the connecting parts the controlling pole may get loose and slide away while too much force is focused on them, and then operating is stopped.

### SUMMARY OF THE INVENTION

The present invention has been accomplished under the circumstances in view. It is one object of the present invention to add a gear part to the shear; with it the force and resistance once concentrated on the connecting parts now can be dispersed. Therefore, the connecting part is not as easy as before to get loose, and the stability, fluency and endurance are increased.

Another purpose of this invention is that the gear part can control the angle of opening and closing of the handles or the blades, preventing it from being too big or too small.

To achieve these and other objects of the present invention, the Garden Shear comprises:
A first blade;
A controlling pole with one side fasted to the first handle, while the first blade can be connected with its other side;
A second blade, spindling connected to the first blade;
The other controlling pole with one side fasted to the second handle, while the other side can be connected with the first blade, and the second blade can slide on it;
A gear part is located between the first end of the controlling pole and the second blade to connect them.

### BRIEF DESCRIPTION OF THE DRAWINGS

FIG. 1 is an exploded view of the garden shear of the present invention.

FIG. 2 is a schematic view showing the garden shear of the present invention in an assembled state;

FIG. 3A is a schematic drawing showing the operation of open the shear when viewing in front of garden shear of the present invention (I).

FIG. 3B is a schematic drawing showing the operation of open the shear when viewing in front of garden shear of the present invention (II).

FIG. 3C is a schematic drawing showing the operation of open the shear when viewing in front of garden shear of the present invention (III).

FIG. 3D is a schematic drawing showing the operation of open the shear when viewing in front of garden shear of the present invention (IV).

### DETAILED DESCRIPTION OF THE PREFERRED EMBODIMENT

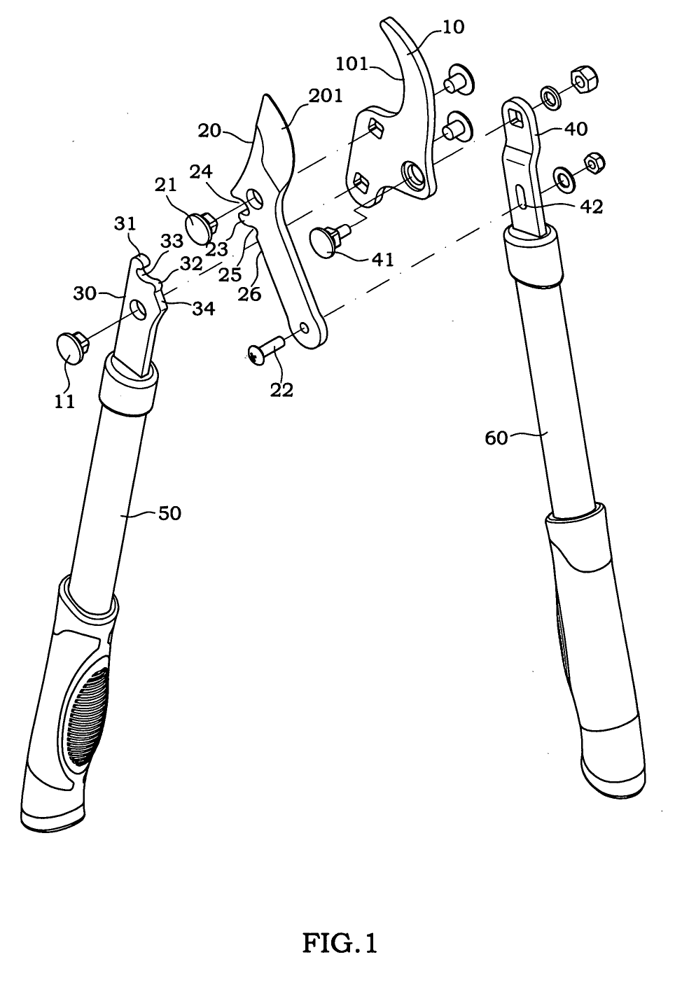

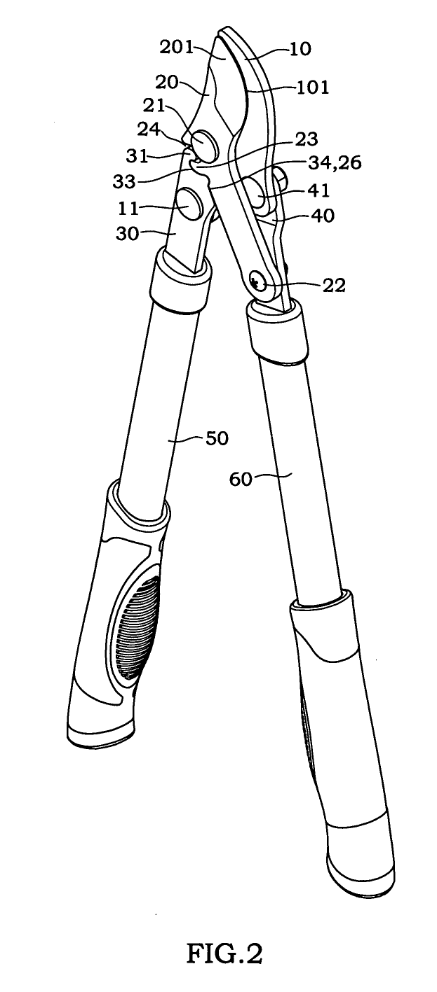

Referring to FIGS. 1 and 2, the shear contains a first blade 10 and a second blade 20, a first controlling pole 30 and a second controlling pole 40, a first handle 50 and a second handle 60. The first blade 10 has a jaw 101, and the second 20 has a blade edge 201. Blade 10 is connected to the first controlling pole 30 at the point 11 while controlling pole 30 is fastened to the first handle 50, and the first blade 10 can roll on the controlling pole 30. Blade 20 is connected to the first blade 10 at the point 21, and can also roll on it. The second controlling pole 40 is connected to the first blade 10 at the point 41, and can roll on it. Controlling pole 40 is also connected to the second blade 20, through a wide hole 42 and axis 22. The second controlling pole 40 is fasted on the second handle 60.

Near the connecting part of the first controlling pole 30 and the second blade 20 there is a gear part. The gear part includes a first protruding tooth 31, a second protruding tooth 32 and a first alveolus 33 between them, near the root of the second protruding tooth 32 there is a first bevel edge 34, which are connected to one side of the first controlling pole 30. While on the second blade 20, a third protruding tooth 23 and near it the third alveolus 24, the fifth alveolus 25 and a second bevel edge 26 near alveolus 25, are connected to it.

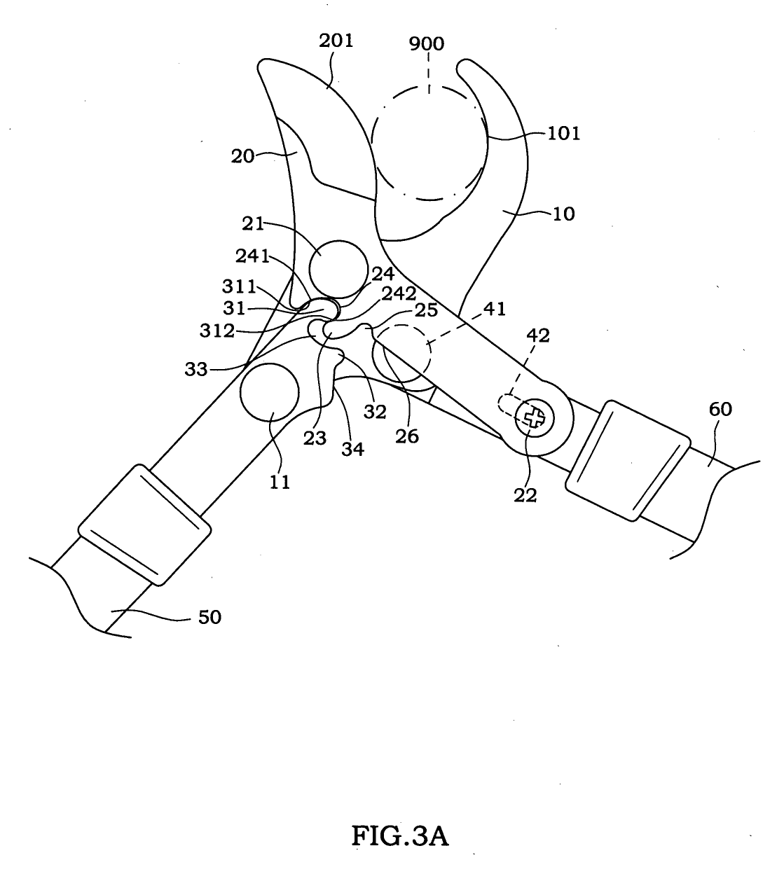

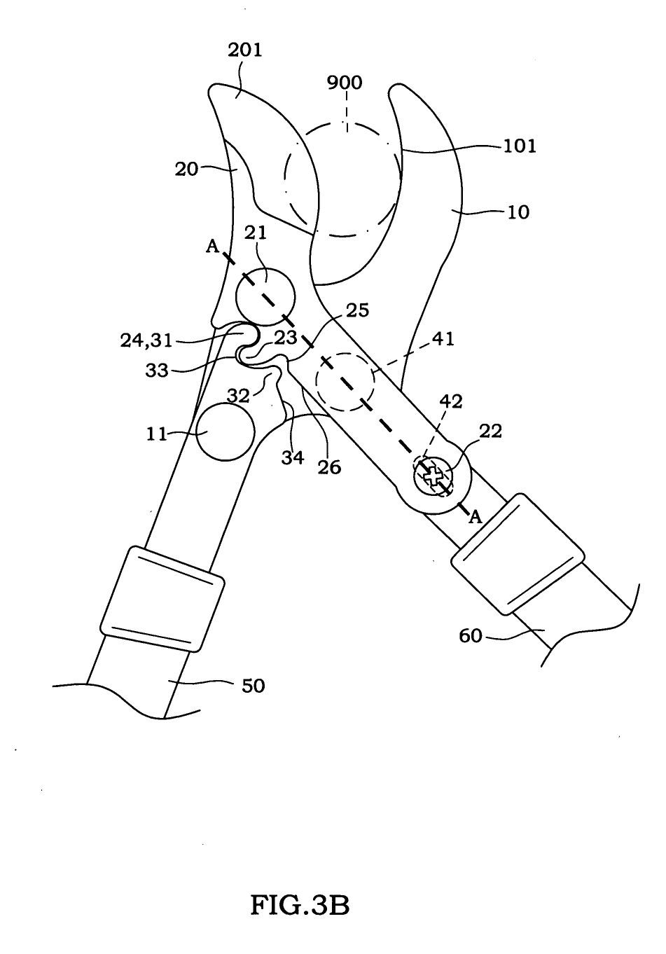

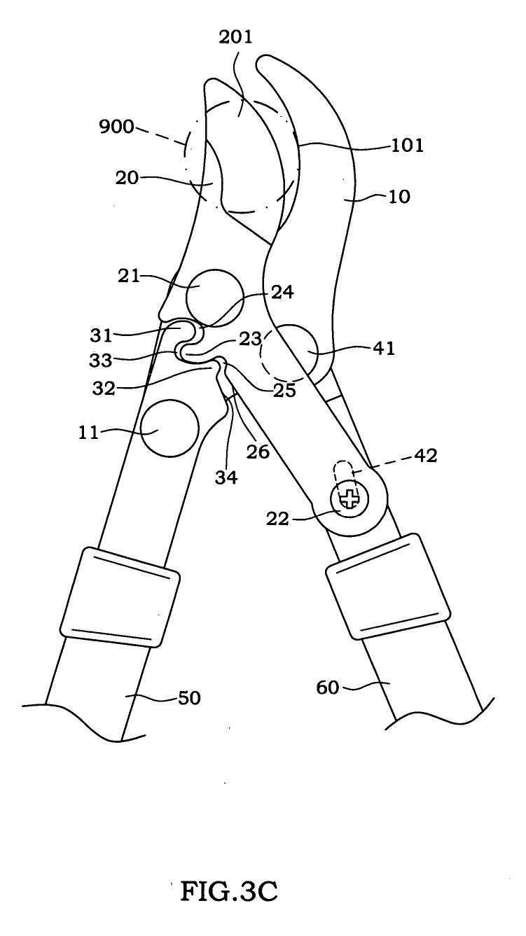

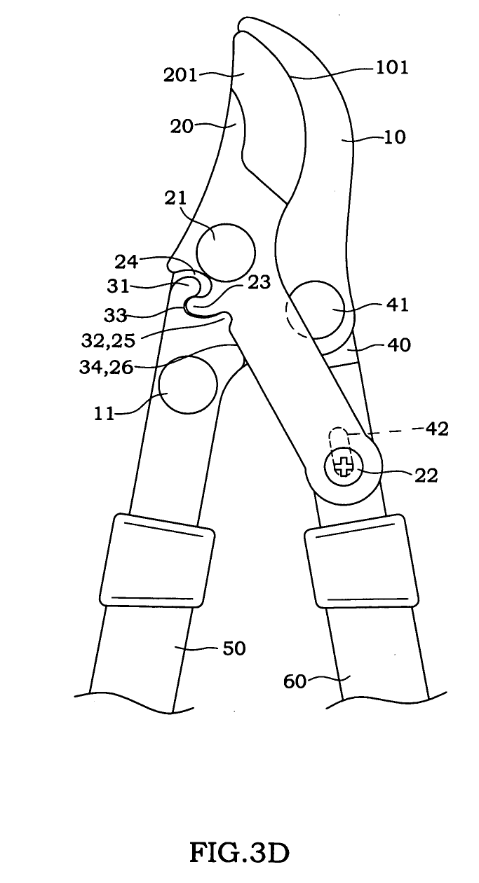

These protruding teeth and alveolus 31 32 33 23 24 25 are not always remain the normal state, they were adjusted to the shear as needed. Referring to FIG. 3A, when the first blade 10 and second blade 20 is opened to the maximum, the two sides of the first protruding tooth 311 312 is well matched with the two sides of the third alveolus 241 242. The third protruding tooth 23 is ready to match with the first alveolus 33. The second protruding tooth 32 is at the fastest distance with the forth alveolus 25. Referring to FIG. 3B shows when the first blade 10 and second blade 20 is moving towards each other to their three axial connecting part 21 31 41 respectively on line A-A, the first protruding tooth 31 is completely matched with the third alveolus 24, while the third protruding tooth 23 is near to the first alveolus 33 but not well-matched.

Referring to FIG. 3C, the first 10 and second blade 20 are nearer to each other and now at the spindly connecting point 41 on line A-A, at this time the first protruding tooth 31 is in the third alveolus 24 but not matched and the second protruding tooth 32 is in the forth alveolus 25 but also not matched. The two sides of the third protruding tooth 33 can slide in the third alveolus 23. Referring to FIG. 3D, the first 10 and second blade 20 are completely closed, the first bevel edge 34 and the second bevel edge 26 is side by side, and the third protruding tooth 23 is totally matched with the first alveolus 33, the second protruding tooth 32 is totally matched with the forth alveolus 25. Match here means they get together exactly well and can still move fluently.

When cutting branch 900, open the shear with its jaw 101 at the edge of branch 900, and then force handle 50 and handle 60 to get closer, that means you use the blade edge 201 to cut branch 900. When the second blade 20 is cutting to the middle of the branch 900 (the same as in FIG. 3B), here the shear encounters the most resistance, so the more force is needed here. Our invention, with the three axial connecting point 21 41 22 on line A-A as discussed above, so level system more efficiently applied to the shear. Therefore, at this most difficult point our shear shows its advantage.

While closing the shear, force focus on handle 50 and handle 60 can be transmitted by the gear part to save strength. The gear part can also distract force and resistance focused on the several axial connecting points, it largely prevent those part from getting loose. Consequently, the stability and fluency in operation and the endurance of shear are greatly increased. Besides, when the handle 50 and handle 60 close, the first bevel edge 34 and the second bevel edge 26 are side by side; when the handle 50 and handle 60 are open to the maximum, the two sides of the first protruding tooth 311 312 are blocked at the two side of the third alveolus 241 242. As the dear part can also have the ability to control the open and close angle of the two handles 50 and 60, preventing them from opening too big or closing too small.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A garden shear comprising:
a first blade;
a first controlling pole with one side fastened to the first handle and the other side connected to the first blade in a spindling way;
a second blade, spindling connected to the first blade;
a second controlling pole with one side fastened to the second handle and the first blade can also spindling connected the other side, while the second blade can slide on the second controlling pole;
a gear part, which is connected to the point where the first controlling handle meet the second blade.

2. The garden shear as claimed in claim 1, wherein said gear part comprising:
a first and second protruding tooth set at one side of the first controlling pole;
an alveolus between the first and second protruding tooth;
the third protruding tooth set on the second controlling pole and can be well matched with the first alveolus;
a third and forth alveolus set near the third protruding tooth and can well be matched with the first and second protruding tooth.

3. The garden shear as claimed in claim 2, said gear part further comprising:
a first bevel edge which is set near to the root of the second protruding tooth and a second bevel edge set near to the forth alveolus.

4. The garden shear as claimed in claim 2, when the first bevel edge and the second bevel edge are side by side, the first and second blade is closed.

5. The garden shear as claimed in claim 4, wherein the second and third protruding tooth are completely matched with the forth alveolus and the first alveolus respectively.

6. The garden shear as claimed in claim 1, wherein said shear is open to the maximum, the two sides of the first protruding tooth is blocking rightly at the two sides of the third alveolus, and the third protruding tooth is away from the first alveolus, while the second protruding tooth is away from the forth alveolus, too.

7. The garden shear as claimed in claim 1, while operating the shear, when the third protruding tooth is in the first alveolus, the third protruding tooth can slide in the third alveolus.

8. The garden shear as claimed in claim 1, wherein said third protruding tooth, the third alveolus and the forth alveolus are all set near the spindling connecting point of the first and second blade.

9. A garden shear comprising:
a first blade;
a first controlling pole with one side fastened to the first handle and the other side connected to the first blade in a spindling way;
a second blade, spindling connected to the first blade;
a second controlling pole with one side fastened to the second handle and the first blade can also spindling connected the other side, while the second blade can slide on the second controlling pole;
a gear part, said gear part further comprising;
a first and second protruding tooth set at one side of the first controlling pole;
an alveolus between the first and second protruding tooth;
the third protruding tooth set on the second controlling pole and can be well matched with the first alveolus;
a third and forth alveolus set near the third protruding tooth and can well be matched with the first and second protruding tooth.

10. The garden shear as claimed in claim 9, wherein said gear part further comprising a first bevel edge which is set near to the root of the second protruding tooth and a second bevel edge set near to the forth alveolus.

11. The garden shear as claimed in claim 10, wherein the first bevel edge and the second bevel edge are side by side, the first and second blade is closed.

12. The garden shear as claimed in claim 11, wherein said second and third protruding tooth are completely matched with the forth alveolus and the first alveolus respectively.

13. The garden shear as claimed in claim 9, wherein the shear is open to the maximum, the two sides of the first protruding tooth is blocking rightly at the two sides of the third alveolus, and the third protruding tooth is away from the first alveolus, while the second protruding tooth is away from the forth alveolus, too

14. The garden shear as claimed in claim 9, while operating the shear, when the third protruding tooth is in the first alveolus, the third protruding tooth can slide in the third alveolus.

15. The garden shear as claimed in claim 9, wherein said third protruding tooth, the third alveolus and the forth alveolus are all set near the spindling connecting point of the first and second blade.

16. A garden shear comprising:
a first blade;
a first controlling pole with one side fastened to the first handle and the other side connected to the first blade in a spindling way;
a second blade connected to the first blade with a spindle;
a second controlling pole with one side fastened to the second handle and the first blade can also spindling connected the other side, while the second blade can slide on the second controlling pole;
a first and second protruding tooth set at one side of the first controlling pole;
an alveolus between the first and second protruding tooth;
the third protruding tooth set on the second controlling pole and can be well matched with the first alveolus;
a third and forth alveolus set near the third protruding tooth and can well be matched with the first and second protruding tooth.
a first bevel edge set near the root of the second protruding tooth and a second bevel edge set near the root of the forth alveolus.

17. The garden shear as claimed in claim 16, wherein said first bevel edge and the second bevel edge are side by side, the first and second blade is closed. The second and third protruding tooth are totally matched in the forth and first alveolus respectively.

18. The garden shear as claimed in claim 16, when the shear is open to the maximum, the two sides of the first protruding tooth is blocking rightly at the two sides of the third alveolus, and the third protruding tooth is away from the first alveolus, while the second protruding tooth is away from the forth alveolus, too.

19. The garden shear as claimed in claim 16, while operating the shear, when the third protruding tooth is in the first alveolus, the third protruding tooth can slide in the third alveolus.

20. The garden shear as claimed in claim 16, wherein the third protruding tooth, the third alveolus and the forth alveolus are all set near the spindling connecting point of the first and second blade.
